(19) United States
(12) Patent Application Publication
(10) Pub. No.: US 2007/0143712 A1
(43) Pub. Date: Jun. 21, 2007

(54) Computer directory display with enhanced navigational and/or visual attributes

(76) Inventor: Kenneth C. Baran, Hebron, CT (US)

Correspondence Address: PRATT & WHITNEY, 400 MAIN STREET, MAIL STOP: 132-13, EAST HARTFORD, CT, 06108, US

(21) Appl. No.: 11/312,138

(22) Filed: Dec. 20, 2005

(51) Int. Cl. G06F 9/00

(52) U.S. Cl. 715/853

(57) ABSTRACT

A user customizable display of a quantity of elements arranged in a hierarchy having at least an upper level and a lower level comprises an interface allowing the user to specify properties of the display such as the quantity of elements displayed at a prescribed level of the hierarchy and visual attributes associated with the elements. In one detailed embodiment, the elements have a default order and the interface is capable of sorting the elements into a different order according to at least one of the visual attributes. The elements may be icons in a display of folder icons associated with a computer memory.

### TECHNICAL FIELD

This invention relates primarily to hierarchical displays of folders or directories such as those commonly used to convey the impression that information stored in a computer storage medium is organized in a way familiar to a human user. In particular, it relates to displaying folders and folder hierarchies in a more useful and satisfactory way.

### BACKGROUND

Computers employ disks or other media to store information. The information is distributed on the storage medium in a way prescribed by the computer designer. Although the information is well organized from the viewpoint of a computer architect, it is not organized and distributed in a way that is intuitive for or familiar to a typical human end user. Therefore, computers also use a visual display to give their users the impression that the information is stored in a hierarchical collection of folders (also referred to as directories) subfolders, sub-subfolders, etc. The user uses a conventional computer mouse and/or keyboard controlled cursor to navigate through the hierarchy to store or retrieve information.

In principle, a user can construct whatever folder hierarchy best suits his needs. However in some environments, such as a large business or governmental organization, there may be practical restrictions on a user's ability to define a folder hierarchy entirely satisfactory for his individual needs and work practices. For example, a folder hierarchy may contain large quantities of organizationally mandated folders, many of which a particular user never needs, or needs only infrequently. As a result, the user may find it necessary to repeatedly navigate back and forth along lengthy stretches of infrequently needed folders to reach the folders of principal interest to him.

Another problem with conventional folder hierarchy displays is that the folders are all visually similar to each other. A user may find it desirable to employ folders that are readily distinguishable from each other by a visual attribute such as color or depicted folder size. In addition, the user may find it desirable to sort folders according to the visual attribute. At present, no faculty for doing so exists.

What is needed is a computer folder display whose properties can be end user customized to be depicted in a way more satisfactory to the end user.

### SUMMARY

According to one embodiment, a user customizable display of elements arranged in a hierarchy includes an interface allowing the user to specify properties of the display, which properties include at least the quantity of elements displayed at a prescribed level of the hierarchy and/or visual attributes associated with the elements. In a more detailed embodiment, the elements are arranged in a default order and the interface is capable of sorting the elements into a different order according to at least one of the visual attributes.

The foregoing and other features will become more apparent from the following detailed description and the accompanying drawings.

### BRIEF DESCRIPTION OF THE DRAWINGS

FIGS. 1A-1F show a conventional display of a folder hierarchy.

FIG. 2 shows a view of a folder hierarchy manipulated according to one aspect of the invention.

FIG. 3 shows a drop down menu to indicate one of many possible methods for controlling the display.

FIG. 4 shows a folder hierarchy in which user assigned visual attributes have been applied to selected folders.

FIG. 5 shows a series of related drop down menus to indicate one way in which the display of FIG. 4 might be sorted according to a visual attribute applied to the selected folders.

FIG. 6 is a view similar to FIG. 4 showing the results of a sort operation.

### DETAILED DESCRIPTION

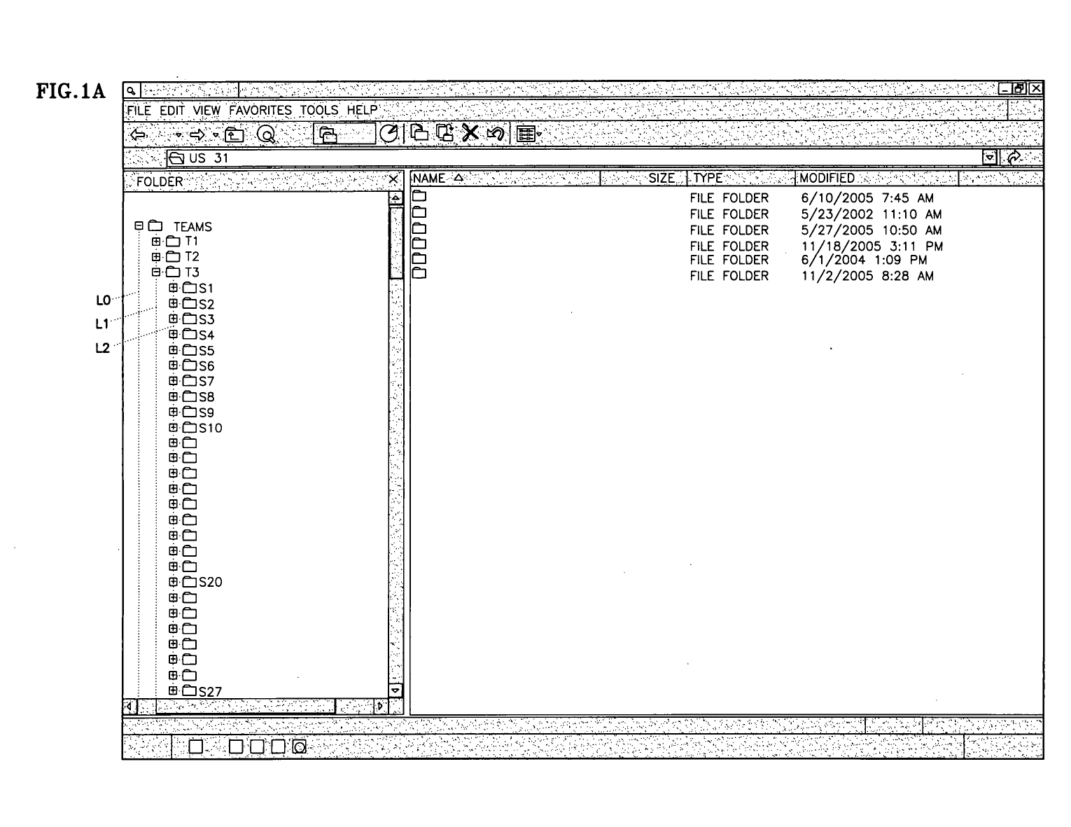

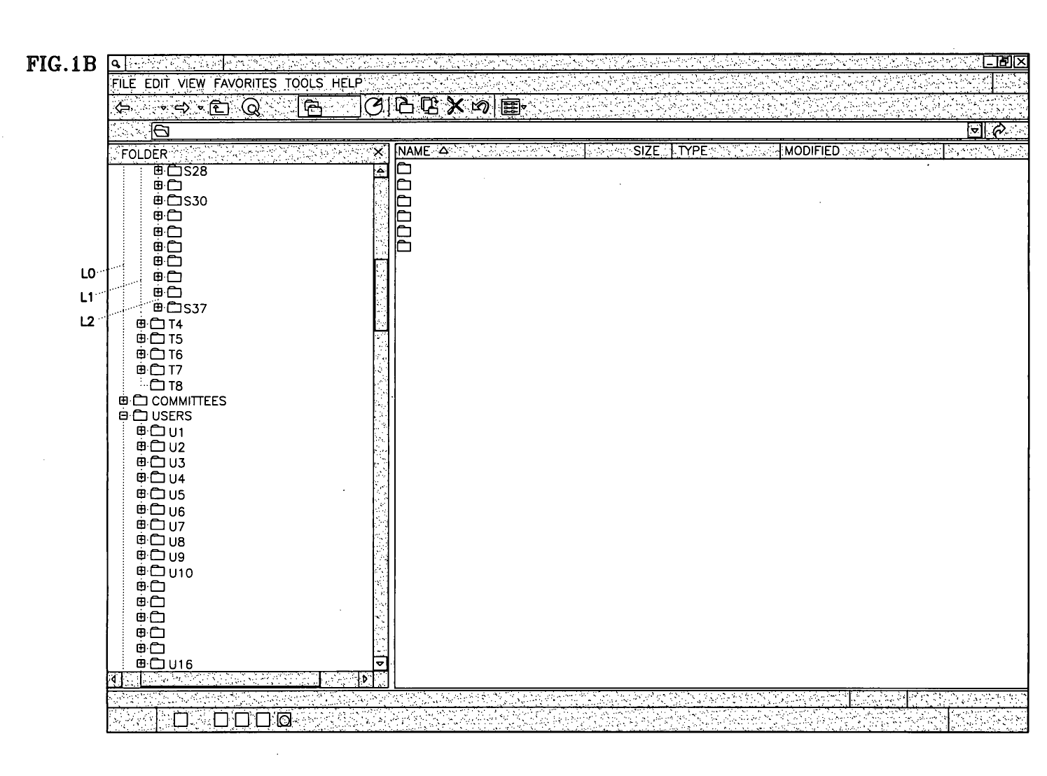

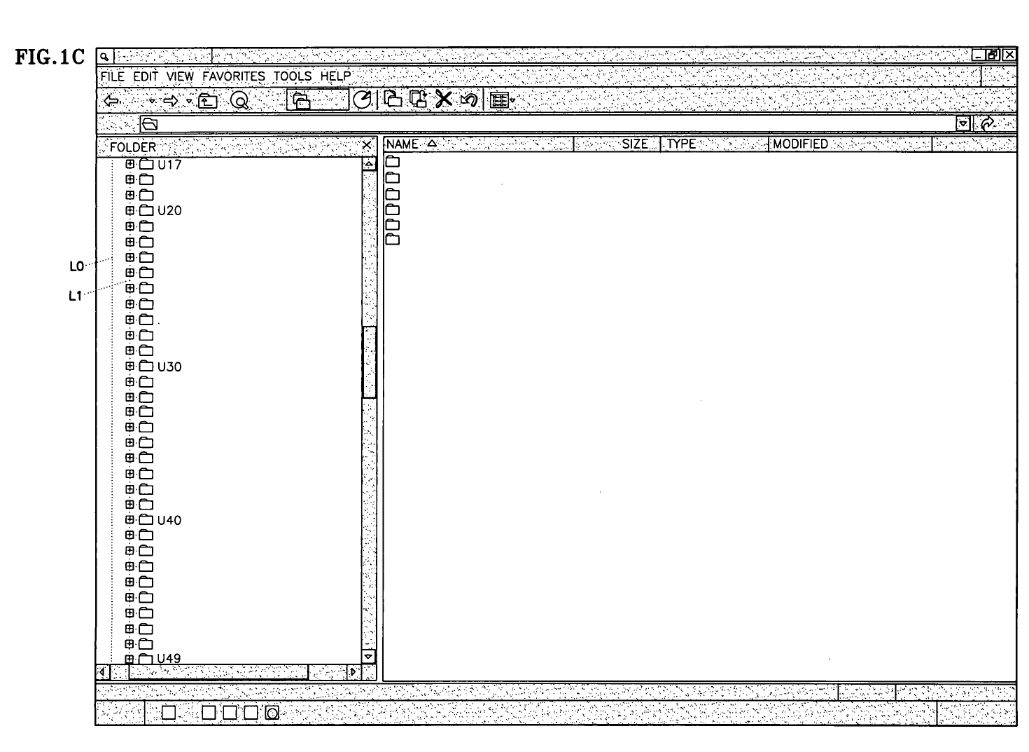

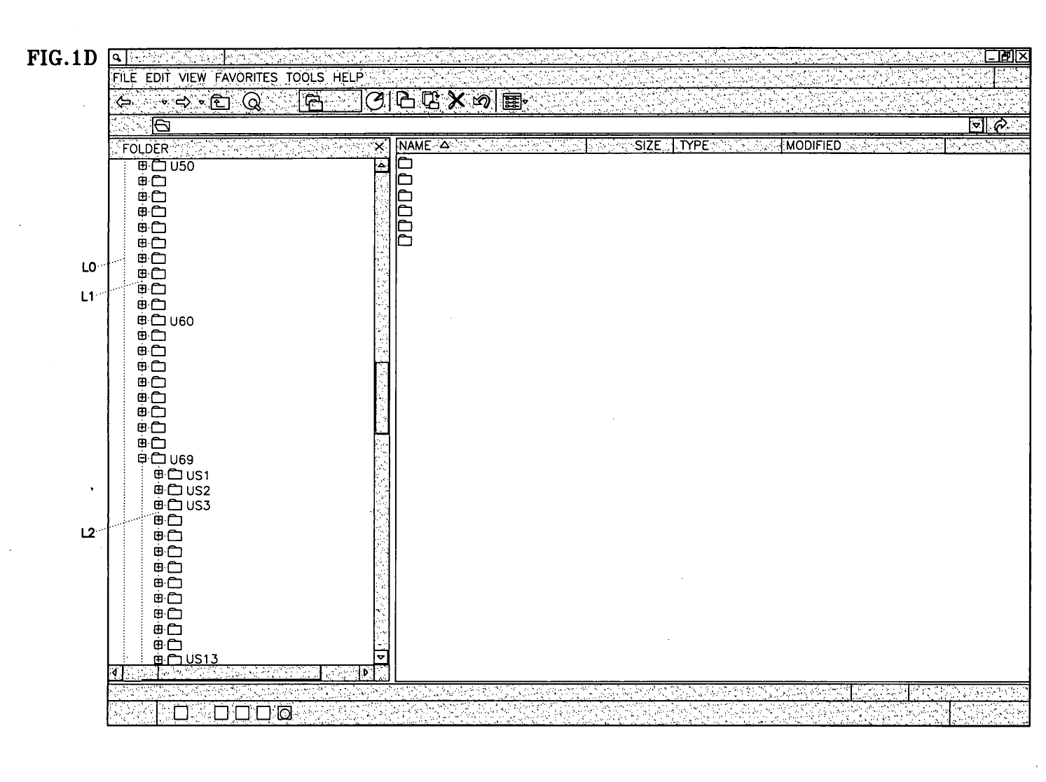

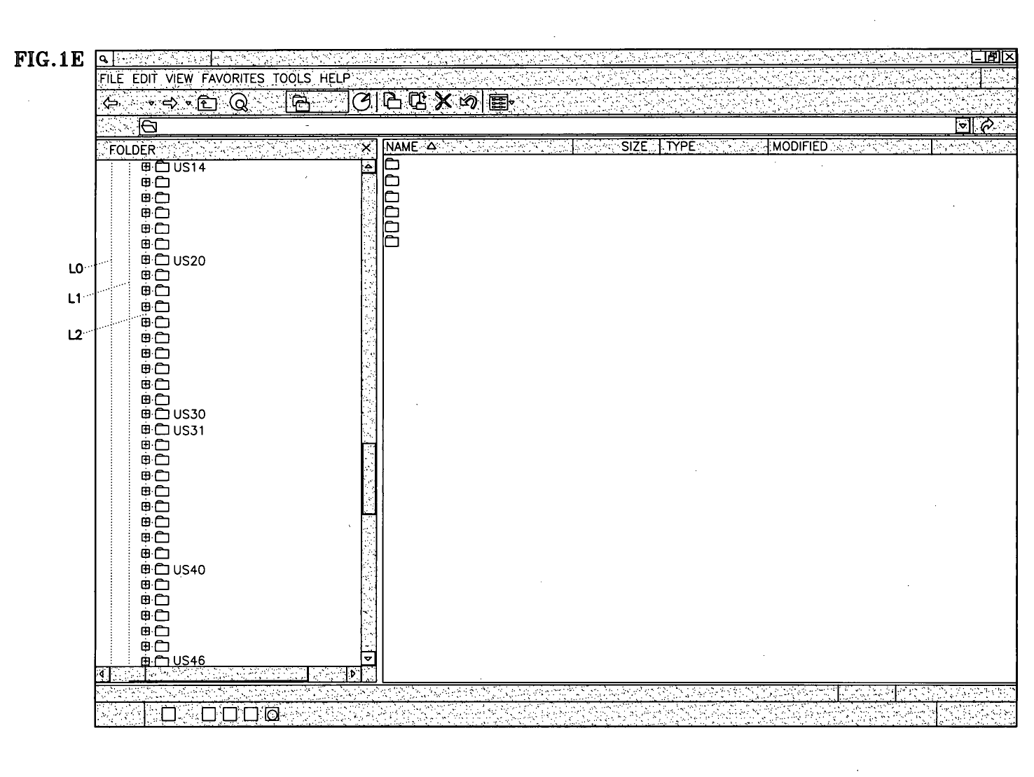

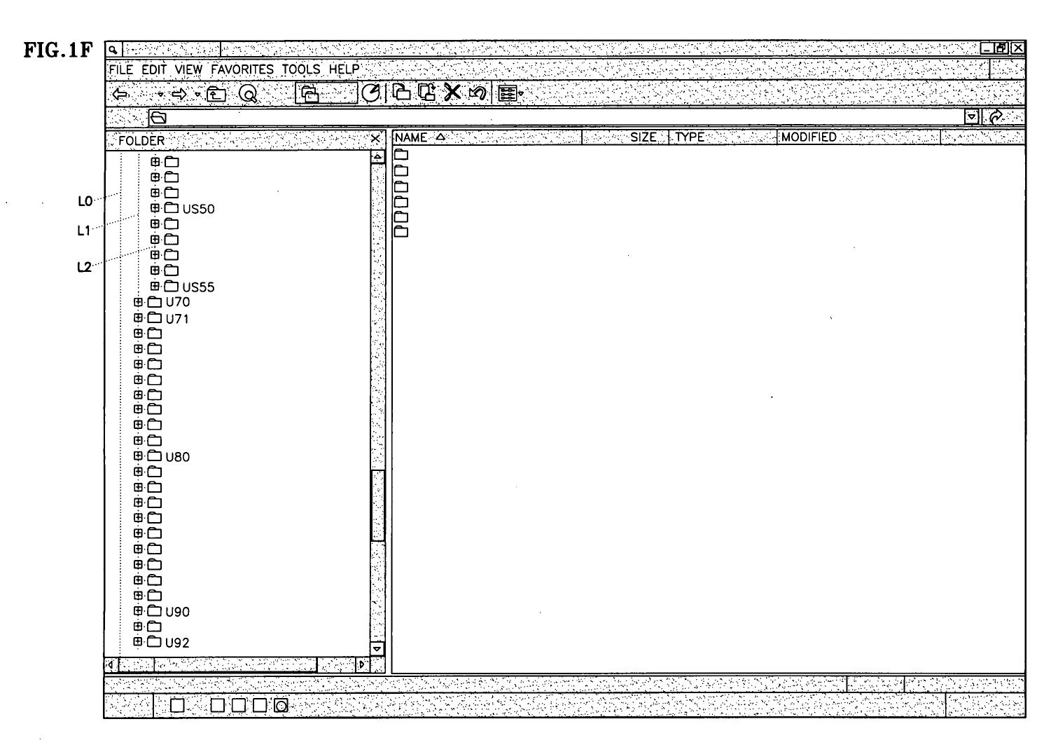

FIGS. 1A-1F show a portion of a conventional computer memory folder hierarchy as displayed to a human end-user on a monitor. The FIGS. show three levels of the folder hierarchy: a high level L0, an intermediate level L1, and a low level L2. The designations L0, L1 and L2 are arbitrary designations not implying that L0 is necessarily the highest level of the hierarchy, or that L2 is the lowest level. The FIGS. show three folders at level L0, one entitled “TEAMS” (FIG. 1A), one entitled “COMMITTEES” (FIG. 1B) and one entitled “USERS” (FIG. 1B). The TEAMS folder is displayed in an expanded state, which reveals that the TEAMS folder includes eight subfolders labeled T1 through T8, one for each of eight work teams in a large organization. In an actual display used by an organization, the subfolder names would typically be more descriptive than T1 through T8. The COMMITTEES folder also includes one or more subfolders, a fact revealed by the “+” symbol to the left of the folder symbol. However the COMMITTEES folder is in a collapsed state, which means that its subfolders are not displayed. The USERS folder, like the TEAMS folder is in an expanded state revealing that it contains 92 subfolders each serving as a storage repository for one of 92 users.

Throughout this specification, the terms “folder”, “subfolder” and “sub-subfolder” are used to indicate the relative hierarchical relationship between folders at different levels, not the absolute level at which a folder resides. Accordingly, a given folder may be referred to as a folder, a subfolder or a sub-subfolder depending on the local context of the discussion. Such usage is consistent with standard practice.

In an organization, each subfolder in the TEAMS folder would contain information of principal interest to all members of the work team for which that folder was established. For example, the information in subfolder T5 would be of interest mostly to members of team t5. This information would be of interest to team non-members only infrequently, if at all. Similarly, each subfolder in the USERS folder contains information of interest to individual members of the organization, but normally of little or no interest to other members of the organization.

TEAMS subfolder T3 has been expanded to reveal that it contains 37 subfolders, S1 through S37 at level L2. Each of these subfolders would typically contain information specific to a project or topic of concern to one or more members of team t3. USERS subfolder U69 has also been expanded to show that its owner, u69, has created 55 personal user subfolders, US1 through US55, at level L2 in order to organize information into meaningful categories.

User subfolders US1 through US55 are in close physical proximity to each other in the display. As a result, user u69 can easily navigate among those folders. However suppose user u69 also serves as a member of work team t3 and therefore also needs to regularly access subfolders in team folder T3. For example suppose that a work task requires repeated access to sub-subfolders US40 and US46 in U69 and sub-subfolder S10 in T3. Because user subfolder U69 and its subfolders US1 through US55 are remote from team folder T3 and its subfolders S1 through S37, the task of continually navigating back and forth between those groups of folders throughout the work day can be tedious and error prone. Of course, the user can considerably shorten the physical distance to be traversed by collapsing T3 and/or U69 at level L1 (in the way that the COMMITTEES folder at level L1 is collapsed) and/or by collapsing TEAMS and USERS at level L0. But these collapsing operations cause the sub-subfolders of interest, e.g. S10, US40 and US46 to be rendered unviewable, and therefore inaccessible.

The inventive folder display overcomes this problem by allowing a folder at level n to be expanded, while concurrently allowing selective suppression and display of the subfolders at sublevels n+1, n+2, etc. (higher numbers indicate lower levels on the hierarchy). Note that the folders at the highest level visible to the user (e.g. L0) can be considered to be residing at a sublevel of a higher level not visible to the user. As a result, these “highest level” folders are also subject to the selective suppression and display.

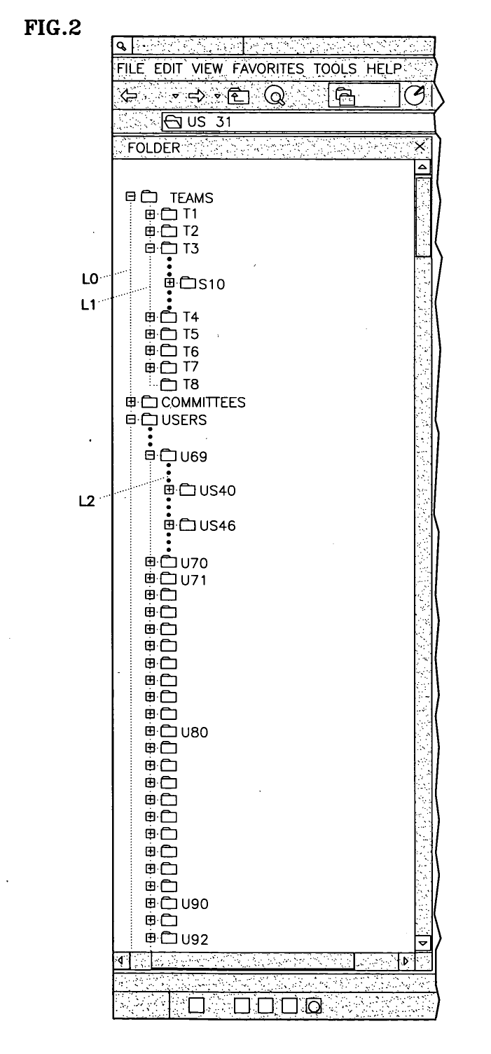

FIG. 2 shows an example applied to the display of FIGS. 1A-1F. In FIG. 2, the TEAMS folder and the T3 subfolder are both in an expanded state as in FIGS. 1A-1F. However the user has exercised the option to suppress display of sub-subfolders S1 through S9 and S11 through S37 so that S10, the folder of interest, is the only one of the subfolders of T3 displayed. The vertical ellipses above and below S10 at level L2 are indicators that reveal to the observer that folders are present but not displayed. The user could have chosen to also suppress the display of level 1 subfolders T1, T2 and T4 through T8.

In FIG. 2 the USERS folder is in an expanded state, but the user has chosen to suppress display of subfolders U1 through U68 since the contents of those folders are rarely, if ever, of interest to user u69. The user could have also chosen to suppress the display of folders U70 through U92 but has elected not to (folders U70 through U92 don't impede navigation between the folders of principal interest (S10 in T3 and US40 and US46 in U69). Within subfolder U69, the user has also chosen to suppress the display of sub-subfolders US1 through US39, US41 through US45 and US47 through US55 because only folders US40 and US46 are of immediate interest. As before, the vertical ellipses at levels L1 and L2 reveal the existence of undisplayed folders.

It is readily apparent that the display of FIG. 2 allows easier navigation from folders US40 and US46 to folder S10 (and vice versa) than is possible with the display of FIGS. 1A-1F.

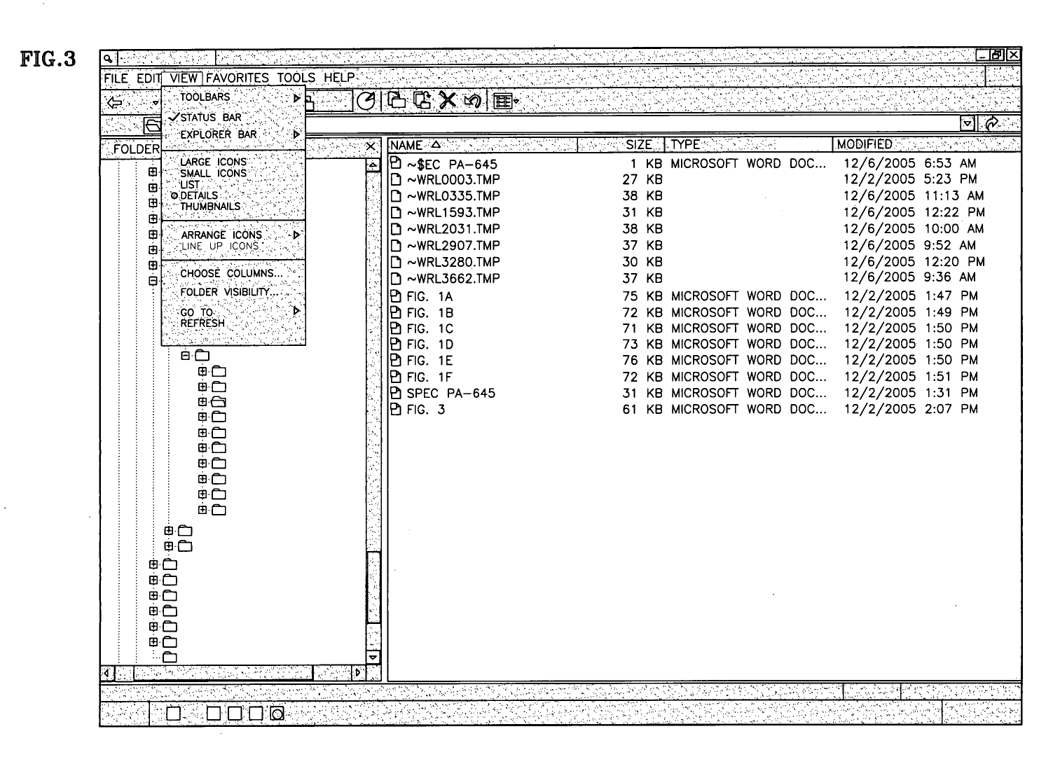

A computer programmer may use an appropriate programming language to code the instructions that the computer responds to in order to manipulate the display. However the user interface for interacting with that code is ideally a graphical user interface (GUI). The GUI may take many forms. One possible way includes a way for the user to indicate individual folders and/or subfolders or ranges of folders and/or subfolders whose visibility is to be altered. The selected folders and subfolders need not be adjacent to each other. Having made the selection, the user then accesses a drop down menu that includes a “folder visibility” option as seen in FIG. 3. For example, a user confronted with the display of FIGS. 1A-1F uses a mouse to select (e.g. by highlighting) sub-subfolders S1 through S9, sub-subfolders S11 through S37, subfolders U1 through U68, sub-subfolders US1 through US39, sub-subfolders US 41 through US45, and sub-subfolders US47 through US55. The user then selects the “folder visibility” option from the “View” drop down menu. The computer responds by suppressing the visibility of the selected folders. The result is the simplified display of FIG. 2.

The reverse process is also provided for. For example a user confronted with the display of FIG. 2 can select one or more of the vertical ellipses and then access the “folder visibility” option to restore the visibility of the folders represented by the ellipses.

It is emphasized that the above examples of suppressing and restoring folder visibility are not limiting. The tools (e.g. drop down menus, dialogue boxes) and the exact order in which those tools are accessed is a matter left to the discretion of the system architect and/or programmer.

A related improvement to conventional computer memory displays involves manipulating the default visual attributes of folders to give those folders a distinctive look desired by the user.

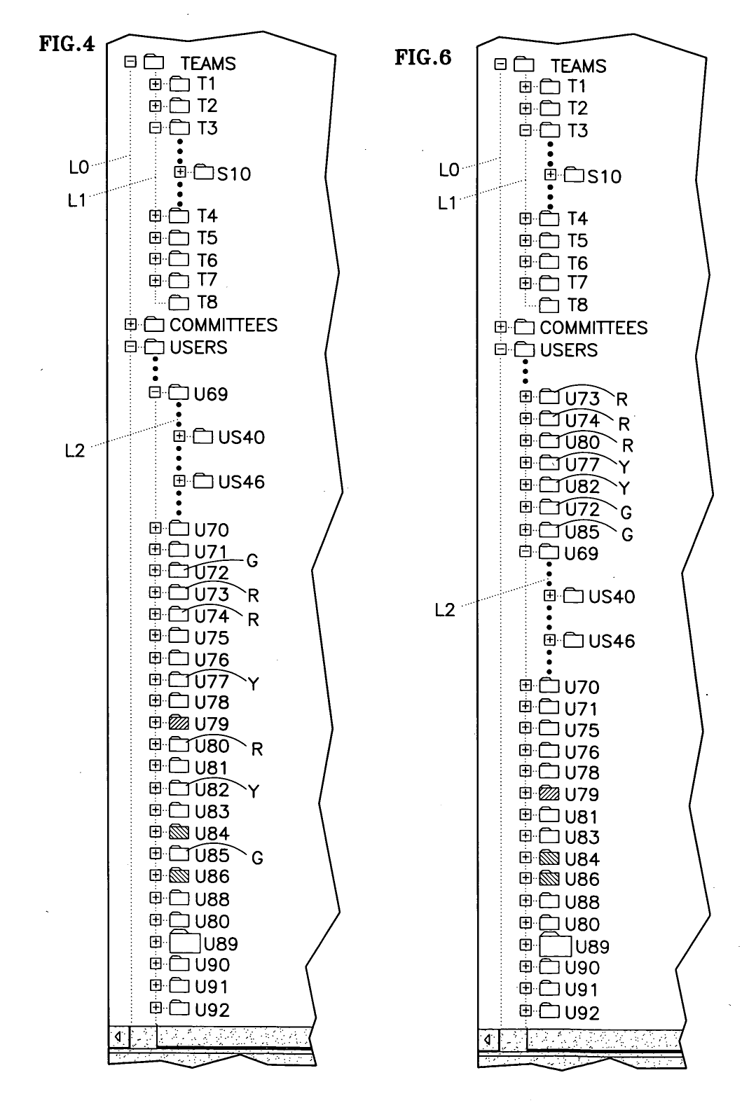

FIG. 4 shows a fragment of the display of FIG. 2 in which a user has applied a visual attribute to selected folders. In the illustration, label “R” signifies that in the actual display folders U73, U74 and U80 are colored red, label “Y” signifies that folders U77 and U82 are colored yellow and label “G” signifies that folders U72 and U85 are colored green. Folder U79 has been crosshatched positively; folders U84 and U86 have been crosshatched negatively. Folder U89 has been enlarged relative to the other folders. Other possible visual attributes include stippling (which might be grouped with various crosshatching options under a more generic heading such as “shading”) and the properties such as size and format (e.g. bold, italics and color) of the font of the text used for the folder name. These visual attributes are selected by the user from a menu of attributes. The attributes have a significance determined by the user to help the user visually identify folders of a particular significance in a large collection of folders.

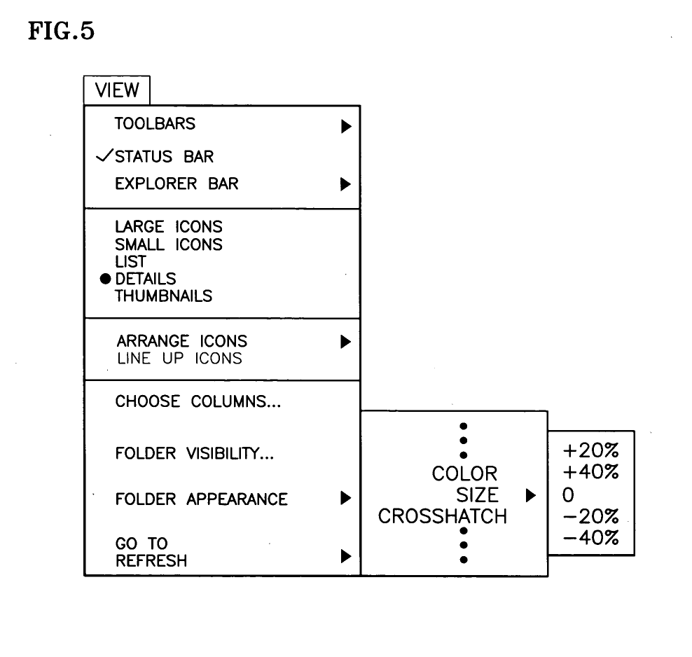

A computer programmer may use an appropriate programming language to code the instructions for allowing the user to assign the visual attributes to selected folders. However the user interface for interacting with that code is ideally a graphical user interface (GUI). The GUI may take various forms. For example, as seen in FIG. 5, a “View” drop down menu includes a “folder appearance” option, a second tier menu includes several options relating to attribute type, and a third tier menu includes specific options associated with the attribute type selected in the second tier menu. As an example, FIG. 5 shows five possible folder size options, however other sizes may be used. Color options, not shown in FIG. 5, may include any collection of colors capable of being displayed. Crosshatch options may include positive and negative crosshatching as seen in FIG. 4. The user assigns the attributes by first selecting the folder or folders whose visual attributes are to be altered. The selected folders and subfolders need not be adjacent to each other. The user then uses the drop down menus to apply the attributes to the selected folders. More that one type of visual attribute may be applied to a single folder.

As with the folder visibility function, the tools (e.g. drop down menus, dialogue boxes), the exact order in which those tools are accessed to modify the visual attributes, and the hierarchical arrangement of the options and sub-options are matters left to the discretion of the system architect and/or programmer.

A capability is also provided to enable a user to sort folders according to their visual attributes. For example, FIG. 6 shows the subfolders of USERS (of FIG. 4) sorted by color. The sorting algorithm is a stable algorithm in which folders not affected by the sort criterion (color) appear in the same relative order as prior to the sort (i.e. they appear in the default order). However the non-colored items may then be sorted, if desired, according to one or more of the other visual attributes that may have been applied to the folders. In addition, folders having multiple user selected attributes (e.g. color and size) can be first sorted by one attribute and then those folders can be subsorted by another attribute.

As already described in the context of specifying folder visibility or specifying visual attributes, sorting folders by visual attributes is preferably accomplished with a GUI. For example, a programmer may employ code allowing the user to highlight a group of folders to be sorted, then specify the attributes of the desired sort (and any subsort).

The foregoing discussion refers to a hierarchy in which the elements at each level of the hierarchy are folders. However the invention may apply to elements other than folders. In addition, although the discussion refers to “folders”, it is to be understood that the folders are actually folder icons.

Although this invention has been shown and described with reference to a specific embodiment thereof, it will be understood by those skilled in the art that various changes in form and detail may be made without departing from the invention as set forth in the accompanying claims.

I claim:

1. A user customizable display of a quantity of elements arranged in a hierarchy having at least a higher level and a lower level, the display comprising an interface allowing the user to specify properties of the display, the specifiable properties including at least one of:
a) the quantity of elements displayed at a prescribed level of the hierarchy; and
b) visual attributes associated with the elements.

2. The display of claim 1 wherein the elements are folder icons for conveying an impression of information organization to a human user of a computer.

3. The display of claim 2 wherein a folder icon at the higher level is associated with a first quantity of folder icons at the lower level and the interface is capable of suppressing visibility of at least some of the first quantity of icons.

4. The display of claim 3 wherein the interface is capable of suppressing the visibility of nonadjacent icons.

5. The display of claim 3 wherein an indicator reveals that icons that have been suppressed are nevertheless present.

6. The display of claim 5 wherein the indicator is an ellipsis.

7. The display of claim 1 wherein the visual attributes include element color, element size, element shading, and properties of text associated with the elements.

8. The display of claim 7 wherein the text properties include font size and font format, the font format comprising font color, font italicization and font boldfacing.

9. The display of claim 1 wherein the elements have a default order and the interface is capable of sorting the elements into a different order according to at least one of the visual attributes.
